(19) United States
(12) Patent Application Publication
(10) Pub. No.: US 2025/0051220 A1
(43) Pub. Date: Feb. 13, 2025

(54) OPTICAL GLASS AND OPTICAL ELEMENT

(71) Applicant: OHARA INC., Sagamihara-shi (JP)

(72) Inventors: Rina Nagashima, Sagamihara-shi (JP); Fumihiro Oguri, Sagamihara-shi (JP)

(73) Assignee: OHARA INC., Sagamihara-shi (JP)

(21) Appl. No.: 18/789,954

(22) Filed: Jul. 31, 2024

(30) Foreign Application Priority Data
Aug. 10, 2023 (JP) 2023-130802
Jun. 21, 2024 (JP) 2024-100834

(51) Int. Cl. C03C 3/097; C03C 3/064; G02B 27/00

(52) U.S. Cl. CPC C03C 3/097; C03C 3/064; G02B 27/005

(57) ABSTRACT

There is provided an optical glass, in which a refractive index (n_{d}) at a wavelength of the d line of helium (587.6 nm) is in a range of 1.45000 to 1.65000; an ISO color contribution index ISO/CCI is 0.00 for blue (B), 0.80 or less for green (G), and 0.80 or less for red (R); and an S value is 0.70×10⁶ or more and less than 1.03×10⁶ (Pa/° C.), the S value being obtained by the equation: S=E·α/(1−ν), in which E is Young's modulus (unit: GPa); α is an average coefficient of linear expansion in a temperature range of 100° C. to 300° C. (unit: 10⁻⁷° C.⁻¹); and ν is Poisson's ratio.

### TECHNICAL FIELD

The present disclosure relates to an optical glass and an optical element, and specifically to an optical glass having: a refractive index that is in a range relatively lower than conventional ones; and a color contribution index with a low degree of color change, the optical glass having excellent formability, high stability in a manufacturing process, and excellent color correction ability in a wide region, as well as an optical element using the optical glass.

### BACKGROUND ART

In the manufacture of an optical element, an optical glass is used as a raw material. Conventionally known methods for producing an optical element from an optical glass include, for example, a method in which a gob or glass block made of an optical glass is ground or polished to form an optical element (e.g., JP2001-166117A), a method in which a gob or glass block made of an optical glass is reheated and molded (reheat press molding) to obtain a glass molded body and the glass molded body is ground or polished (e.g., JP2001-19446A), and a method in which a preform material obtained from a gob or glass block is molded in an ultra-precisely machined mold (precision mold press molding) to form an optical element (e.g., JP2005-281106A).

As a recent method for producing an optical element, there is also known a method in which glass plates made of an optical glass are polished, coated, and stacked, and the stacked glass plates undergo cutting, cleaning, polishing, and forming steps, etc. to produce an optical element.

However, when many steps are involved in the manufacture of an optical element from an optical glass, there is a problem that the inherent properties of the optical glass change, resulting in that the physical properties of the optical element are affected. In particular, the cutting and forming steps have a large effect on the physical properties of the optical element, and the optical element is prone to cracking or chipping. For these reasons, there is a demand for an optical glass having excellent formability and high stability in a manufacturing process.

In recent years, the use of optical elements for wearable applications such as AR (augmented reality), VR (virtual reality), and MR (mixed reality) and mobile device applications has been increasing. Examples thereof include: wearable applications such as eyeglasses with a projector, eyeglass-type and goggle-type displays, virtual reality and augmented reality display devices, and a virtual image display device; and mobile device applications such as a mobile phone and a smart phone.

For example, the following publications disclose inventive optical glasses for wearable applications. JP2019-511449A discloses, as an optical glass that can be used in a virtual or augmented reality device, an inventive optical glass having a high refractive index of more than 1.65 at the wavelength, λ=587.6 nm. In addition, JP2021-102549A discloses an inventive optical glass having: a composition containing at least one selected from TiO₂ and Nb₂O₅, and B₂O₃; and a refractive index n_{d} of 1.95 or more. Furthermore, JP2021-31378A discloses an inventive optical glass that contains, by mol % in terms of oxide, 9.0 to 11.0% of SiO₂, 22.0 to 24.0% of B₂O₃, 18.0 to 20.0% of La₂O₃, and 30.0 to 31.0% of TiO₂, and has a high refractive index in a range of 1.90 to 2.10.

These are all inventive optical glasses having a high refractive index, which were made from a viewpoint that a high refractive index is required for an optical glass for wearable applications. However, in order to increase the refractive index, a glass needs to contain a high proportion of components that significantly increase the refractive index of the glass, such as TiO₂ or Nb₂O₅. The high proportion of the components that significantly increase the refractive index contained in the glass makes the vitrification unstable. In order to stabilize the vitrification, the glass needs to contain a high proportion of B₂O₃. For example, in JP2021-31378A mentioned above, the optical glass contains as much as 30.0 to 31.0% of TiO₂ and as much as 22.0 to 24.0% of B₂O₃, by mol % in terms of oxide, to achieve the high refractive index in the range of 1.90 to 2.10.

However, depending on the configuration and design freedom of an optical element used in a wearable device or a mobile device, the optical element is not necessarily required to have a high refractive index. When used for producing an optical element that is not required to have a high refractive index, an optical glass is not necessarily required to have a high refractive index. When an optical glass is not necessarily required to have a high refractive index, the optical glass does not need to contain a high proportion of components that significantly increase the refractive index of the glass, such as TiO₂ or Nb₂O₅. Accordingly, the optical glass does not need to contain a high proportion of B₂O₃ to stabilize the vitrification.

It is a color contribution index with a low degree of color change and excellent color correction ability in a wide region that are required in an optical glass used for the manufacture of a wearable or mobile device that is not necessarily required to have a high refractive index.

### PATENT DOCUMENT

[Patent Document 1] JP2001-166117A
[Patent Document 2] JP2001-19446A
[Patent Document 3] JP2005-281106A
[Patent Document 4] JP2019-511449A
[Patent Document 5] JP2021-102549A
[Patent Document 6] JP2021-31378A
[Patent Document 7] Japanese Patent No. 4537317

### SUMMARY OF THE DISCLOSURE

The present disclosure has been made in view of the above problems. The present disclosure provides an optical glass having: a refractive index (n_{d}) that is in a range relatively lower than conventional ones; and a color contribution index with a low degree of color change, the optical glass having excellent formability, high stability in a manufacturing process, and excellent color correction ability in a wide region, as well as an optical element using the optical glass.

In order to solve the above problems, in an optical glass according to the present disclosure, a refractive index (n_{d}) at a wavelength of the d line of helium (587.6 nm) is in a range of 1.45000 to 1.65000, an ISO color contribution index ISO/CCI is 0.00 for blue (B), 0.80 or less for green (G), and 0.80 or less for red (R), and an S value obtained by the following equation (1) is 0.70×10⁶ or more and less than 1.03×10⁶ (Pa/° C.). In Equation (1), E is Young's modulus (unit: GPa), α is an average coefficient of linear expansion in a temperature range of 100° C. to 300° C. (unit: 10⁻⁷° C.⁻¹), and ν is Poisson's ratio.

$$S = E \cdot α / ( 1 - v ) \qquad Equation ( 1 )$$

Preferably, an upper limit value of the refractive index (n_{d}) is 1.64000.

Preferably, the ISO color contribution index ISO/CCI is 0.00 for blue (B), 0.70 or less for green (G), and 0.70 or less for red (R).

Preferably, the S value is 0.73×10⁶ or more and less than 1.00×10⁶ (Pa/° C.).

In one embodiment, a total content of a TiO₂ component, a Nb₂O₅ component, a Bi₂O₃ component, and a WO₃ component is 10.0% or less by mol % in terms of oxide.

In one embodiment, the optical glass contains, by mol % in terms of oxide, 30.0 to 80.0% of a SiO₂ component and 0.00 to 30.0% of a B₂O₃ component in a sum that does not exceed 100.0%.

An optical element according to the present disclosure is an optical element, including the optical glass.

In one embodiment, the optical element is used with a transparent resin plate or a curable resin material.

In one embodiment, the optical element is used in a wearable device or a mobile device.

The present disclosure provides an optical glass having: a refractive index (n_{d}) that is in a range relatively lower than conventional ones; and a color contribution index with a low degree of color change, the optical glass having excellent formability, high stability in a manufacturing process, and excellent color correction ability in a wide region. The optical glass is suitable for wearable applications such as AR (augmented reality), VR (virtual reality), and MR (mixed reality) and for mobile device applications.

### DESCRIPTION OF EMBODIMENTS

Hereinafter, an optical glass and an optical element using the same according to the present disclosure will be described in detail.

### [A: Optical Glass of the Present Disclosure]

### 1. Color Contribution Index (ISO/CCI)

As described above, an optical glass according to the present disclosure is an optical glass having a color contribution index with a low degree of color change. Specifically, when the color condition is expressed by the ISO color contribution index (ISO/CCI) defined in the Japan Industrial Standards, the optical glass has an ISO color contribution index (ISO/CCI) of 0.00 for blue (B), 0.80 or less for green (G), and 0.80 or less for red (R) when converted to a flat plate with a thickness of 10 mm.

The color contribution index (CCI) is an index for predicting how much the color of a color photograph taken using a certain lens system will change compared to the original color due to the spectral characteristics of the lens. It is indicated by a set of three values determined for blue (B), green (G), and red (R). Using the ISO/CCI, it is possible to predict how much the color will be changed by a glass material itself. For measurement and calculation of the CCI, JIS B 7097 can be referred to.

In general, the ISO/CCI of optical glasses indicates a property that the better the light transmittance in the short wavelength region of visible light, the smaller the G and R values when the B value of the ISO/CCI is set to 0. However, when an optical glass with a high refractive index is to be obtained, the devitrification resistance and meltability will deteriorate. If the melting temperature or time is increased in order to improve the devitrification resistance and meltability, the G and R values of the ISO/CCI of a glass bulk material will increase and the color balance will deteriorate, which is a disadvantage. In addition, since a high refractive index glass having a refractive index (n_{d}) of, for example, 1.78 or more has poor light transmittance in the short wavelength region, the G and R values of the ISO/CCI of a glass bulk material are large and the color balance is not good.

However, in the case of an optical glass used in the manufacture of a wearable or mobile device that is not necessarily required to have a high refractive index, not only the B value but also the G and R values of the ISO/CCI of a glass bulk material may be small since a high refractive index is not required. Accordingly, good color balance can be ensured, and an optical glass having a color contribution index with a low degree of color change can be obtained. Furthermore, an optical element made using the optical glass having a color contribution index with a low degree of color change can provide a user with an image or video that is closer to actual colors, and is therefore suitable for wearable applications such as AR, VR, and MR, as well as for mobile device applications.

Thus, the optical glass according to the present disclosure has a color condition expressed by the ISO/CCI of 0.00 for blue (B) and 0.80 or less for green (G) when converted to a flat plate with a thickness of 10 mm. The value for green is more preferably 0.70 or less, and still more preferably 0.60 or less. The red (R) is 0.80 or less. The value for red is also more preferably 0.70 or less, and still more preferably 0.60 or less.

### 2. Mechanical Properties (Thermal Shock Resistance)

In general, the stress (σ) generated in a glass bulk material due to thermal shock can be predicted by the following equation:

$$σ = λ \cdot E \cdot α \cdot Δ T / ( 1 - v )$$

Here, λ is a constant related to the shape and heat transfer rate of a glass, E is Young's modulus (GPa), α is an average coefficient of linear expansion (10⁻⁷° C.⁻¹) in a temperature range of 100° C. to 300° C., AT is a temperature difference, and ν is Poisson's ratio.

As mentioned above, ΔT is a temperature difference and is therefore a parameter of a manufacturing process, not a property of a glass bulk material. Hence, it is the following three values that are significantly dependent on the composition of a glass: Young's modulus (E), an average coefficient of linear expansion (α) in a temperature range of 100° C. to 300° C., and Poisson's ratio (ν).

In order to enhance the thermal shock resistance of an optical glass, it is particularly desirable that S=E·α/(1−ν) be low. The applicant of the present application also discloses, in the specification of Japanese Patent No. 4,537,317, an inventive optical glass having high thermal shock resistance, in which the value of S=E·α/(1−ν) is 1.00×10⁶ to 1.35×10⁶ (Pa ° C.⁻¹), from a viewpoint that obtaining a glass material having both a low Young's modulus (E) and a low average coefficient of linear expansion (α) is an important point for manufacturing an optical glass having high thermal shock resistance. The reason why such high thermal shock resistance is required is that an optical glass is required to have high thermal shock resistance so as to prevent a crack or chip from occurring during a manufacturing process of an optical element, such as mold press molding, even when a drastic change in temperature, such as a rapid increase or decrease in temperature, occurs in the manufacturing process.

Since recent wearable devices and mobile devices drastically and rapidly generate heat during operation, the thermal shock resistance of conventional glasses may not be sufficient. It is necessary to employ a glass with higher thermal shock resistance.

Therefore, in the present disclosure, the composition of the optical glass is adjusted such that the S value obtained by Equation (1) below is 0.70×10⁶ or more and less than 1.03×10⁶ (Pa/° C.) to enhance the production stability and formability of the optical glass. By designing it to be in such a range, the optical glass can have a coefficient of thermal expansion in a suitable range and can be excellent in formability and less likely to crack or chip during a manufacturing process. On the other hand, if the S value is too large, the risk of frequent manufacturing defects of cracks and chips tends to increase significantly. Hence, an upper limit value thereof is set at 1.03×10⁶ (Pa/° C.).

The optical glass of the present disclosure can be suitably used as a light guide plate. When using the optical glass of the present disclosure as a light guide plate, glass substrates thereof are bonded to each other. It is preferable that the difference in average coefficient of linear expansion between the bonded substrates (hereinafter referred to as a substrate 1, a substrate 2, . . . , and a substrate n) be ±3.0×10⁻⁷ or less. An upper limit of the difference in average coefficient of linear expansion of the substrate 1 to the substrate n is preferably ±3.0×10⁻⁷ or less, more preferably ±2.0×10⁻⁷ or less, and still more preferably ±1.0×10⁻⁷ or less. Such a small difference in linear expansion between the substrate 1 to the substrate n can suppress misalignment or peeling due to the difference in linear expansion between the bonded glass substrates even when heat is applied to the light guide plate.

S=Eα/(1−ν) Equation (1)

In Equation (1), E is Young's modulus (unit: GPa), α is an average coefficient of linear expansion in a temperature range of 100° C. to 300° C. (unit: 10⁻⁷° C.⁻¹), and ν is Poisson's ratio.

The S value of 0.70×10⁶ or more and less than 1.03×10⁶ (Pa/° C.) is even lower than the S value of the high thermal shock resistant optical glass disclosed in the specification of the above-mentioned Japanese patent No. 4,537,317 (1.00×10⁶ to 1.35×10⁶ (Pa ° C.⁻¹)). Therefore, in the optical glass according to the present disclosure, a crack or chip is less likely to occur during a manufacturing process, so that the production stability and formability of the optical glass can be enhanced.

As described above, in the present disclosure, the composition is adjusted such that the S value is 0.70×10⁶ or more and less than 1.03×10⁶ (Pa/° C.). However, a lower limit of the S value is preferably 0.73×10⁶ or more (Pa/° C.), more preferably 0.75×10⁶ (Pa/° C.) or more, and still more preferably 0.80×10⁶ or more (Pa/° C.). An upper limit of the S value is preferably less than 1.00×10⁶ (Pa/° C.), and more preferably less than 0.98×10⁶ (Pa/° C.). For example, in a preferred embodiment, the S value is 0.73×10⁶ or more and less than 1.00×10⁶ (Pa/° C.).

### 3. Refractive Index (n_{d})

The optical glass of the present disclosure has a refractive index (n_{d}) at a wavelength of the d line of helium (587.6 nm) with a lower limit value of 1.45000 and an upper limit value of 1.65000, that is, in the range of 1.45000 to 1.65000. As already described above, the optical glass disclosed in JP2021-102549A has the refractive index of 1.95 or more, and the optical glass disclosed in JP2021-31378A has the refractive index in the range of 1.90 to 2.10. Hence, the value of the refractive index (n_{d}) of the optical glass according to the present disclosure is considerably lower than those of conventional optical glasses for wearable applications. This is a result of the present disclosure being made from the viewpoint that it is a color contribution index with a low degree of color change and excellent color correction ability in a wide region that are required for an optical glass used in the manufacture of a wearable or mobile device that is not necessarily required to have a high refractive index.

Depending on the configuration and design freedom of an optical element in which the optical glass according to the present disclosure is used, the lower limit of the refractive index (n_{d}) may be 1.48000 or more, 1.50000 or more, or 1.51000 or more. The upper limit of the refractive index (n_{d}) may be 1.64000 or less, 1.63000 or less, 1.62000 or less, or 1.61000 or less.

### 4. Optical Homogeneity

Inhomogeneity of the refractive index inside an optical glass has a large effect on the optical properties thereof and causes a deterioration in the properties of an optical element. In this respect, the optical glass according to the present disclosure has high homogeneity and accordingly has an excellent refractive index distribution. The refractive index distribution of the optical glass of the present disclosure is preferably within 0.00050, still more preferably within 0.00030, still more preferably within 0.00010, still more preferably within 0.00007, and still more preferably within 0.00005. The homogeneity of refractive index is measured by calculating the PV value, Δn_{pν}, of refractive index fluctuation width (excluding linear change component of refractive index) out of the amount of change in refractive index within a surface to be measured, for example, by using a Fizeau interferometer in Oil-on plate method or Polished test part Homogeneity method.

### 5. Abbe Number

Abbe number (inverse variance rate) is an index for evaluating color dispersion of a transparent body (variation in refractive index depending on wavelength). The larger the Abbe number, the smaller the dispersion. The Abbe number of the optical glass according to the present disclosure is larger than those of conventional glasses, indicating low dispersion. A lower limit value of the Abbe number of the optical glass according to the present disclosure is preferably 35.00 or more, more preferably 38.00 or more, still more preferably 40.00 or more, and furthermore preferably 42.00 or more. On the other hand, an upper limit value of the Abbe number is preferably 70.00 or less, more preferably 68.00 or less, still more preferably 67.00 or less, and furthermore preferably 65.00 or less.

### 6. Specific Gravity

Although there is no particular limitation on the specific gravity of the optical glass according to the present disclosure, it is preferably 4.50 or less, more preferably 4.00 or less, still more preferably 3.80 or less, and furthermore preferably 3.50 or less, from a viewpoint of weight reduction of an optical element.

### 7. Ratio of Specific Gravity and Refractive Index

In the optical glass of the present disclosure, the ratio of the specific gravity d and the refractive index n_{d}, d/n_{d} is preferably less than 2.1, more preferably less than 2.0, and still more preferably less than 1.9. A glass material satisfying such a condition is advantageous as a glass material for an optical element of the present disclosure, for example for a lens for a smart phone or a prism of a periscope camera. For example, in order to reduce the weight of a prism, there are a method of reducing the volume of the prism by using a glass having a relatively high refractive index, and a method of using a glass having a low specific gravity. The present disclosure employs the latter method. In this case, d/n_{d} is preferably less than 2.1, more preferably less than 2.0, still more preferably less than 1.9, and most preferably less than 1.85.

### 8. Composition

Hereinafter, a composition of the optical glass according to the present disclosure will be described. Unless otherwise specified, the content rate of each component will be expressed by mol %. In this specification, the phrase “not substantially contain” means that a component is not blended as a raw material component, that is, that it is not intentionally included. The phrase does not exclude that it may be mixed in as an impurity.

As will be described later, in one embodiment of the optical glass according to the present disclosure, a total content of a TiO₂ component, a Nb₂O₅ component, a Bi₂O₃ component, and a WO₃ component is 10.0% or less by mol % in terms of oxide, and the optical glass contains, by mol % in terms of oxide, 30.0 to 80.0% of a SiO₂ component, and 0.00 to 30.0% of a B₂O₃ component in a sum that does not exceed 100.0%.

In this specification, the phrase “in terms of oxide” means that the components of the composition of a glass are expressed based on the assumption that oxides, composite salts, metal fluorides, and the like used as raw materials of the glass constituent components of the present disclosure are all decomposed and converted to oxides during melting, with the total weight of the generated oxides being taken as 100 mol %.

SiO₂ component: A SiO₂ component is a glass forming component. It imparts high strength, glass stability, and chemical durability and betters formability. It can also reduce expansion. A lower limit value of the content of the SiO₂ component is preferably 40% or more, and more preferably 43% or more, 45% or more, 48% or more, and 50% or more in this order. An upper limit value of the content of the SiO₂ component is preferably 90% or less, more preferably 85% or less, 80% or less, 78% or less, and 75% or less in this order.

Na₂O component: A Na₂O component is a component that enhances the meltability and formability of a glass. On the other hand, if the content of the Na₂O component is high, the impact resistance decreases. The optical glass of the present disclosure may be an optical glass that does not substantially contain the Na₂O component (0%), but if it contains the Na₂O component, a lower limit value thereof is preferably more than 0%, and more preferably 0.1% or more, 0.5% or more, and 1.0% or more in this order. An upper limit value of the content of the Na₂O component is preferably 20% or less, more preferably 15% or less, 14% or less, 13% or less, 12% or less, 11% or less, and 10% or less in this order.

BaO component: A BaO component is a component that enhances the meltability of an optical glass and increases the refractive index of a glass. On the other hand, if the content of the BaO component is high, the impact resistance decreases. The optical glass of the present disclosure may be an optical glass that does not substantially contain the BaO component (0%), but if it contains the BaO component, a lower limit value thereof is preferably more than 0%, and more preferably 0.1% or more, 0.5% or more, and 1.0% or more in this order. An upper limit value of the content of the BaO component is preferably 30% or less, more preferably 28% or less, 25% or less, and 20% or less in this order.

B₂O₃ component: A B₂O₃ component is a glass forming component. It enhances devitrification resistance and betters formability. It can also reduce expansion. The optical glass of the present disclosure may be an optical glass that does not substantially contain the B₂O₃ component (0%), but if it contains the B₂O₃ component, a lower limit value thereof is preferably more than 0%, and more preferably 0.1% or more, 0.5% or more, 0.8% or more, and 1.0% or more in this order. An upper limit value of the content of the B₂O₃ component is preferably 30% or less, more preferably 25% or less, 23% or less, and 20% or less in this order.

K₂O component: A K₂O component is a component that enhances the meltability and formability of an optical glass. On the other hand, if the content of the K₂O component is high, the impact resistance decreases. The optical glass of the present disclosure may be an optical glass that does not substantially contain the K₂O component (0%), but if it contains the K₂O component, a lower limit value thereof is preferably more than 0%, and more preferably 0.1% or more, 0.5% or more, and 1.0% or more in this order. An upper limit value of the content of the K₂O component is preferably 20% or less, more preferably 15% or less, 14% or less, 13% or less, 12% or less, 11% or less, and 10% or less in this order.

Li₂O component: A Li₂O component is a component that enhances the meltability and formability of an optical glass. On the other hand, if the content of the Li₂O component is high, the impact resistance decreases. The optical glass of the present disclosure may be an optical glass that does not substantially contain the Li₂O component (0%), but if it contains the Li₂O component, a lower limit value thereof is preferably more than 0%, and more preferably 0.1% or more, 0.5% or more, and 1.0% or more in this order. An upper limit value of the content of the Li₂O component is preferably 20% or less, more preferably 15% or less, 14% or less, 13% or less, 12% or less, 11% or less, and 10% or less in this order.

Al₂O₃ component: An Al₂O₃ component is a component that enhances the impact resistance and devitrification resistance of an optical glass and reduces the expansion of a glass. It is also a component that suppresses phase separation of a glass and enhances devitrification resistance. The optical glass of the present disclosure may be an optical glass that does not substantially contain the Al₂O₃ component (0%), but if it contains the Al₂O₃ component, a lower limit value thereof is preferably more than 0%, and more preferably 0.1% or more, 0.5% or more, and 1.0% or more in this order. An upper limit value of the content of the Al₂O₃ component is preferably 10% or less, more preferably 8% or less, 6% or less, and 5% or less in this order.

TiO₂ component: A TiO₂ component is a component that increases the refractive index of a glass. On the other hand, if the content of the TiO₂ component is high, it causes coloration of a glass. The optical glass of the present disclosure may be an optical glass that does not substantially contain the TiO₂ component (0%), but if it contains the TiO₂ component, a lower limit value thereof is preferably more than 0%, and more preferably 0.1% or more, 0.5% or more, and 1.0% or more in this order. An upper limit value of the content of the TiO₂ component is preferably 20% or less, more preferably 15% or less, 14% or less, 13% or less, 12% or less, 11% or less, and 10% or less in this order.

Nb₂O₅, Bi₂O₃, and WO₃ components: Nb₂O₅, Bi₂O₃, and WO₃ components are each a component that increases the refractive index of a glass. On the other hand, if the content thereof is high, they cause coloration of a glass. The optical glass of the present disclosure may be an optical glass that does not substantially contain the Nb₂O₅ component, the Bi₂O₃ component, and the WO₃ component (0%), but if it contains the Nb₂O₅ component, the Bi₂O₃ component, or the WO₃ component, a lower limit value of each of these components is preferably more than 0%, and more preferably 0.1% or more, 0.5% or more, and 1.0% or more in this order. An upper limit value of the content of each of the Nb₂O₅ component, the Bi₂O₃ component, and the WO₃ component is preferably 10% or less, more preferably 8% or less, 5% or less, 3% or less, 2% or less, and 1% or less in this order.

CaO component: A CaO component is a component that enhances meltability and increases the refractive index of a glass. On the other hand, if the content of the CaO component is high, the impact resistance decreases. The optical glass of the present disclosure may be an optical glass that does not substantially contain the CaO component (0%), but if it contains the CaO component, a lower limit value thereof is preferably more than 0%, and more preferably 0.1% or more, 0.5% or more, and 1.0% or more in this order. An upper limit value of the content of the CaO component is preferably 30% or less, more preferably 28% or less, 25% or less, and 20% or less in this order.

ZnO component: A ZnO component is a component that enhances meltability and increases the refractive index of a glass. On the other hand, if the content of the ZnO component is high, the impact resistance decreases. The optical glass of the present disclosure may be an optical glass that does not substantially contain the ZnO component (0%), but if it contains the ZnO component, a lower limit value thereof is preferably more than 0%, and more preferably 0.1% or more, 0.5% or more, and 1.0% or more in this order. An upper limit value of the content of the ZnO component is preferably 10% or less, more preferably 8% or less, 5% or less, 3% or less, 2% or less, and 1% or less in this order.

ZrO₂ component: A ZrO₂ component can be added for the purpose of adjusting an optical constant and improving the durability of a glass. However, the ZrO₂ component may deteriorate the stability as a glass. It is hence preferable that the optical glass of the present disclosure does not substantially contain the ZrO₂ component, but if it contains the ZrO₂ component, an upper limit value thereof is preferably 5.0% or less, more preferably 4.0% or less, 3.0% or less, 2.0% or less, and 1.0% or less in this order.

F component: A F component is effective for obtaining high transmittance and can provide an optical glass having a low transition temperature (Tg).

In the optical glass of the present disclosure, the F component is considered to be present in the form of a fluoride in which a part of or all of the oxygen atoms of one or two or more oxides of silicon or another metal element are substituted with the F component. If the total amount, as F, of the fluoride in which a part of or all of the oxygen atoms of said oxides are substituted is too large, the amount of volatilization of the fluorine component increases, making it difficult to obtain a homogeneous glass. Hence, the F component should not be added if it would hinder stable production. Therefore, in the present disclosure, an upper limit value of the F component is preferably 5.0% or less, more preferably 3.0% or less, 1.0% or less, 0.5% or less, and 0.3% or less in this order. The optical glass of the present disclosure may not substantially contain the F component.

Ta₂O₅ component: A Ta₂O₅ component is a component that increases the refractive index of a glass and enhances the devitrification resistance of the glass. On the other hand, by setting the content of the Ta₂O₅ component to 5.0% or less, the amount of use of the Ta₂O₅ component, which is a rare mineral resource, is reduced and the glass melts more easily at a lower temperature. Consequently, glass production costs can be reduced. This also reduces devitrification of the glass caused by an excessive content of the Ta₂O₅ component. Therefore, an upper limit value of the content of the Ta₂O₅ component is preferably 5.0% or less, more preferably 3.0% or less, and still more preferably 1.0% or less, or may be 0%.

P₂O₅ component: An upper limit value of the content of a P₂O₅ component is preferably 5.0% or less, more preferably 3.0% or less, more preferably 1.0% or less, and still more preferably 0.5% or less, or may be 0%.

TeO₂ component: An upper limit value of the content of a TeO₂ component is preferably 3.0% or less, more preferably 2.0% or less, more preferably 1.0% or less, and still more preferably 0.5% or less, or may be 0%.

Ga₂O₃ component: An upper limit value of the content of a Ga₂O₃ component is preferably 3.0% or less, more preferably 2.0% or less, more preferably 1.0% or less, and still more preferably 0.5% or less, or may be 0%.

GeO₂ component: An upper limit value of the content of a GeO₂ component is preferably 3.0% or less, more preferably 2.0% or less, more preferably 1.0% or less, and still more preferably 0.5% or less, or may be 0%.

CeO₂ component: An upper limit value of the content of a CeO₂ component is preferably 3.0% or less, more preferably 2.0% or less, more preferably 1.0% or less, and still more preferably 0.5% or less, or may be 0%.

Er₂O₃ component and Pr₂O₃ component: The contents of an Er₂O₃ component and a Pr₂O₃ component are each preferably 1.0% or less, more preferably 0.5% or less, and more preferably 0.1% or less. Most preferably, the optical glass of the present disclosure does not substantially contain these components.

SnO₂ component: An upper limit value of the content of a SnO₂ component is preferably 2.0% or less, more preferably 1.0% or less, and still more preferably 0.5% or less, or may be 0%.

Sb₂O₃ component: A Sb₂O₃ component is a component that promotes clarification and defoaming during glass melting, and is optional. Here, by setting the content of the Sb₂O₃ component to 0.10% or less, it becomes possible to suppress coloration, particularly in a high refractive index glass. In addition, by setting the content to 0.1% or less, excessive foaming is less likely to occur during glass melting, making it difficult for the Sb₂O₃ component to alloy with melting equipment (in particular, equipment made of a precious metal such as Pt). Therefore, an upper limit value of the content of the Sb₂O₃ component is preferably 0.1% or less, more preferably 0.08% or less, and still more preferably 0.05% or less, or may be 0%.

Note that the component for clarification and defoaming of the glass is not limited to the above-mentioned Sb₂O₃ component, and any known clarifying or defoaming agent or a combination thereof in the field of glass manufacturing can be used.

C component: A C component is a component that can maintain a reducing atmosphere inside a platinum crucible, suppress a mixing of platinum into a glass due to oxidation, and improve the transmittance. However, if the content of the C component is high, a cation component in the glass is reduced and coloration occurs in the glass. Therefore, an upper limit value of the content of the C component is preferably 10.0% or less, more preferably 8.0% or less, more preferably 6.0% or less, and most preferably 5.0% or less. On the other hand, a lower limit value of the content of the C component is preferably more than 0%, more preferably 0.5% or more, still more preferably 1.0% or less, and most preferably 2.0% or less, or may be 0%.

S component: A S component is a component that can maintain a reducing atmosphere inside a platinum crucible, suppress a mixing of platinum into a glass due to oxidation, and improve the transmittance. However, if the content of the S component is high, a cation component in the glass is reduced and coloration occurs in the glass. Therefore, an upper limit value of the content of the S component is preferably 10.0% or less, more preferably 8.0% or less, more preferably 6.0% or less, and most preferably 5.0% or less. On the other hand, a lower limit value of the content of the S component is preferably more than 0%, more preferably 0.5% or more, still more preferably 1.0% or less, and most preferably 2.0% or less, or may be 0%.

Organic component such as sucrose: An organic component such as sucrose is a component that can maintain a reducing atmosphere inside a platinum crucible, suppress a mixing of platinum into a glass due to oxidation, and improve the transmittance. However, if the content of the organic component such as sucrose is high, a cation component in the glass is reduced and coloration occurs in the glass. Therefore, an upper limit value of the content of the organic component such as sucrose is preferably 10.0% or less, more preferably 8.0% or less, more preferably 6.0% or less, and most preferably 5.0% or less. On the other hand, a lower limit value of the content of the organic component such as sucrose is preferably more than 0%, more preferably 0.5% or more, still more preferably 1.0% or less, and most preferably 2.0% or less, or may be 0%.

Note that the component for the reduction of cations is not limited to the above-mentioned C component, S component, and organic component such as sucrose, and any known reducing agent or a combination thereof in the field of glass manufacturing can be used.

By setting a total content of the TiO₂ component, the Nb₂O₅ component, the Bi₂O₃ component, and the WO₃ component to 10.0% or less, it is possible to reduce the refractive index while suppressing an increase in specific gravity. Therefore, an upper limit value of the total content of the TiO₂ component, the Nb₂O₅ component, the Bi₂O₃ component, and the WO₃ component is preferably 10.0% or less, more preferably 8.0% or less, still more preferably 5.0% or less, still more preferably 3.0% or less, and still more preferably 1.0% or less.

A sum (molar sum) of the content of a Ln₂O₃ component, in which Ln is one or more selected from the group consisting of La, Y, Gd, and Yb, can increase the refractive index of a glass, but if it is contained in excess, it increases the devitrification property of the glass. Therefore, an upper limit value of the sum of the content of the Ln₂O₃ component is preferably 5.0% or less, more preferably 4.0% or less, still more preferably 3.0% or less, still more preferably 2.0% or less, and still more preferably 1.0% or less.

A sum (molar sum) of the content of a Rn₂O component, in which Rn is one or more selected from the group consisting of Li, Na, and K, can enhance the meltability of a glass, but if it is contained in excess, it worsens the devitrification resistance during processing. By enhancing the meltability, it is possible to obtain a glass with good productivity. Therefore, an upper limit value of the sum of the content of the Rn₂O component is preferably 20.0% or less, more preferably 18.0% or less, and still more preferably 16.0% or less. On the other hand, a lower limit value of the sum of the content of the Rn₂O component is preferably more than 0%, more preferably 0.1% or more, still more preferably 0.2% or more, still more preferably 0.3% or more, or still more preferably 0.4% or more.

A sum (molar sum) of the content of a RO component, in which R is one or more selected from the group consisting of Mg, Ca, Sr, and Ba, can enhance the stability of a glass, but if it is contained in excess, it causes a decrease in refractive index. Therefore, an upper limit value of the sum of the content of the RO component is 30.0% or less, more preferably 28.0% or less, still more preferably 26.0% or less, and still more preferably 25.0% or less. On the other hand, a lower limit value of the sum of the content of the RO component is preferably more than 0%, more preferably 0.1% or more, still more preferably 0.3% or more, still more preferably 0.4% or more, or still more preferably 0.5% or more.

By setting a molar sum, Rn₂O+RO, which is a total content of the Rn₂O component and the RO component, to 10.0% or more, it is possible to enhance the meltability of a glass and obtain a stable glass. Therefore, a lower limit value of the molar sum, Rn₂O+RO, is preferably 10.0% or more, more preferably 12.0% or more, still more preferably 13.0% or more, still more preferably 14.0% or more, and still more preferably 15.0% or more. On the other hand, by setting the molar sum, Rn₂O+RO, to 40.0% or less, it is possible to suppress an excessive decrease in refractive index. Therefore, an upper limit value of the molar sum, Rn₂O+RO, is preferably 40.0% or less, more preferably 38.0% or less, still more preferably 35.0% or less, still more preferably 33.0% or less, and still more preferably 30.0% or less.

By setting a molar ratio (SiO₂+B₂O₃+Al₂O₃)/(Rn₂O+RO) of the molar sum SiO₂+B₂O₃+Al₂O₃, which is the total content of the SiO₂ component, the B₂O₃ component and the Al₂O₃ component, to the molar sum Rn₂O+RO, which is the total content of the Rn₂O component and the RO component, to 1.00 or more, the chemical durability can be enhanced. Therefore, a lower limit value of the molar ratio (SiO₂+B₂O₃+Al₂O₃)/(Rn₂O+RO) is preferably 1.00 or more, more preferably 1.30 or more, still more preferably 1.50 or more, still more preferably 1.80 or more, and still more preferably 2.00 or more. On the other hand, by setting the molar ratio (SiO₂+B₂O₃+Al₂O₃)/(Rn₂O+RO) to 7.00 or less, the meltability can be maintained. Therefore, an upper limit value of the molar ratio (SiO₂+B₂O₃+Al₂O₃)/(Rn₂O+RO) is preferably 7.00 or less, more preferably 6.80 or less, still more preferably 6.50 or less, still more preferably 6.30 or less, and still more preferably 6.00 or less.

<Components that should not be Included>

Next, components that should not be included and components that are not preferably included in the optical glass of the present invention will be described.

Another component may be added as necessary within a range that does not impair the properties of the glass of the present disclosure. However, transition metal components such as Nd, V, Cr, Mn, Fe, Co, Ni, Cu, Ag and Mo excluding Ti, Zr, Nb, W, La, Gd, Y, Yb, and Lu, have properties of coloring a glass and causing absorption at a specific wavelength in the visible region even if a small amount of the transition metal components is contained singly or in combination. Therefore, it is preferable that the transition metal components are not contained, particularly in an optical glass that uses a wavelength in the visible region.

A lead compound such as PbO and an arsenic compound such as As₂O₃ are components with a high environmental load. Hence, it is desirable that the optical glass of the present disclosure does not substantially contain them, that is, the optical glass of the present disclosure does not contain them at all except for unavoidable contamination.

In addition, Th, Cd, Tl, Os, Be, and Se components have recently tended to be avoided since they are considered harmful chemicals, and environmental measures are required not only in a manufacturing process of a glass but also in a processing process and disposal after commercialization. Therefore, if an emphasis is placed on environmental impact, it is preferable that the optical glass of the present disclosure does not substantially contain them.

In one embodiment of the optical glass according to the present disclosure, the total content of the TiO₂ component, the Nb₂O₅ component, the Bi₂O₃ component, and the WO₃ component is 10.0% or less by mol % in terms of oxide.

In one embodiment, the optical glass according to the present disclosure contains, by mol % in terms of oxide, 30.0 to 80.0% of the SiO₂ component and 0.00 to 30.0% of the B₂O₃ component in a sum that does not exceed 100.0%.

### 9. Manufacturing Method

The optical glass of the present disclosure is produced, for example, as follows. That is, the above raw materials are mixed uniformly such that the content of each component is within a predetermined range, and the prepared mixture is charged into a platinum crucible. The mixture is melted in an electric furnace in a temperature range of 1100 to 1500° C. for 2 to 5 hours depending on the difficulty of melting the glass raw materials, stirred and homogenized. Then, the temperature thereof is lowered to an appropriate temperature, and it is cast into a mold and cooled slowly, thereby producing the optical glass of the present disclosure. In particular, the optical glass of the present disclosure is preferably produced at a lower lehr speed in a forming step from a viewpoint of reducing distortion. Specifically, it is preferably 400 mm/min, still more preferably 300 mm/min, and still more preferably 220 mm/min.

The optical glass described above provides an optical glass having: a refractive index (n_{d}) that is in a range relatively lower than conventional ones; and a color contribution index with a low degree of color change, the optical glass having excellent formability, high stability in a manufacturing process, and excellent color correction ability in a wide region.

### [B: Optical Element Made of the Optical Glass of the Present Disclosure]

The optical glass according to the present disclosure is suitable for use for an optical element that is not required to have a high refractive index, and is particularly suitable for wearable applications such as AR, VR, and MR, and for mobile device applications.

Examples thereof include: wearable applications such as eyeglasses with a projector, eyeglass-type and goggle-type displays, virtual reality and augmented reality display devices, and a virtual image display device; and mobile device applications such as a mobile phone and a smart phone. These optical elements may be, for example, an optical element used with a transparent resin plate or a curable resin material.

### EXAMPLES

Table 1 shows the compositions of optical glasses of Examples 1 to 9. Table 2 shows the physical properties thereof.

The optical glasses of Examples 1 to 9 were produced as follows. High-purity raw materials used in ordinary optical glasses such as oxides, hydroxides, carbonates, nitrates, fluorides, and metaphosphate compounds were selected as raw materials for the components. The raw materials were weighed to the proportion of each composition shown in Table 1, uniformly mixed, charged into a platinum crucible, melted in an electric furnace in a temperature range of 1000 to 1500° C. for 2 to 4 hours depending on the difficulty of melting each glass composition, stirred and homogenized, cast into a mold, and cooled slowly.

The refractive index (n_{d}) and Abbe number (ν_{d}) of each glass of Examples 1 to 9 were measured according to the V-block method defined in JIS B 7071-2: 2018. Here, the refractive index (n_{d}) is indicated by a value measured with respect to the d line (587.56 nm) of a helium lamp. The Abbe number (ν_{d}) was calculated by the equation, Abbe number (ν_{d})=[(n_{d}-1)/(n_{F}-n_{C})], using the refractive index (n_{d}) with respect to the d line of the helium lamp as well as a refractive index (n_{F}) with respect to the F line (486.13 nm) and a refractive index (n_{C}) with respect to the C line (656.27 nm) of a hydrogen lamp. The refractive index (n_{d}) and the Abbe number (ν_{d}) were obtained by measuring the glasses obtained with the cooling temperature at a rate of −25° C./hr.

The ISO color contribution index (ISO/CCI) of each glass of Examples was measured as follows. Referring to JISB7097 (Determination of ISO Color Contribution Index (ISO/CCI) of Camera Lenses), the G value (green) and the R value (red) when B (blue) was set to 0 were obtained to two decimal places.

The Young's modulus (E), rigidity (G), and Poisson's ratio (ν) of each glass of Examples were measured by an ultrasonic pulse method using a sample of 100×10×10 mm.

The average coefficient of linear expansion (α) of each glass of Examples was obtained for −30 to 70° C. and 100 to 300° C. in accordance with Japan Optical Glass Manufacturers' Association Standard JOGIS16-2019 “Measuring method for average linear thermal expansion coefficient of optical glass at normal temperature.”

The specific gravity of each glass of Examples was measured by an in-liquid weighing method of the methods of measuring density and specific gravity of JISZ8807:2019.

The physical properties of the optical glasses of Examples 1 to 9 obtained by the above-described methods are shown in Table 2.

TABLE 1

| COMPOSITION | EXAMPLES | | | | | | | | |
|---|---|---|---|---|---|---|---|---|---|
| mol % | 1 | 2 | 3 | 4 | 5 | 6 | 7 | 8 | 9 |
| SiO₂ | 69.30 | 70.90 | 55.19 | 46.81 | 46.21 | 42.00 | 74.03 | 73.22 | 63.38 |
| B₂O₃ | 12.26 | 11.23 | 10.34 | 16.69 | 17.79 | 3.16 | 9.82 | 10. 18 | |
| Al₂O₃ | 0.70 | 0.70 | 0.29 | 5.16 | 4.20 | 0.00 | | 0.06 | |
| Nb₂O₃ | | | | | | | | | |
| Bi₂O₃ | | | | | | | | | |
| TiO₂ | | | | 0.00 | 1.14 | 14.43 | 0.04 | 0.01 | 10.88 |
| WO₃ | | | | | | | | | |
| La₂O₂ | | | | | | | | | |
| Y₂O₃ | | | | | | | | | |
| Gd₂O₃ | | | | | | | | | |
| Yb₂O₃ | | | | | | | | | |
| ZrO₂ | | | | 3.82 | | | | | |
| ZnO | 0.80 | 0.80 | | 0.00 | 3.03 | | | 0.79 | |
| MgO | | | | | | | | | |
| CaO | | | | 0.00 | 0.48 | | | | 5.40 |
| SrO | | | | | | | | | |
| BaO | 1.51 | 1.07 | | 27.49 | 27.14 | | 0.96 | 0.64 | 7.74 |
| Li₂O | | | | | | | | | |
| Na₂O | 10.03 | 9.95 | | 0.00 | | | 9.84 | 9.83 | 4.54 |
| K₂O | 5.37 | 5.32 | 10.65 | 0.00 | | 12.27 | 5.26 | 5.25 | 8.04 |
| Sb₂O₂ | 0.02 | 0.02 | 0.01 | 0.03 | 0.03 | 0.01 | 0.04 | 0.02 | 0.02 |
| F | | | 23.52 | 0.00 | | 28.12 | | | |
| total | 100 | 100 | 100 | 100 | 100 | 100 | 100 | 100 | 100 |
| TiO₃ + Nb₂O₅ + | 0.00 | 0.00 | 0.00 | 0.00 | 1.14 | 14. 49 | 0. 04 | 0.01 | 10.88 |
| Bi₂O₃ + WO₃ | | | | | | | | | |
| Ln₂O₃ | 0.00 | 0.00 | 0.00 | 0.00 | 0.00 | 0.00 | 0.00 | 0.00 | 0. 00 |
| Ro₂O | 15.4 | 15.3 | 10.7 | 0.0 | 0.0 | 12.3 | 15.1 | 15. 1 | 12.6 |
| RO | 1.513 | 1.074 | 0.000 | 27.492 | 27.617 | 0.000 | 0. 957 | 0.642 | 13.138 |
| Rn₂O + RO | 16.913 | 16.350 | 10.650 | 27.492 | 27.617 | 12. 274 | 16. 054 | 15.724 | 25.716 |
| (SiO₂ + B₂O₃ + Al₃O₃)/ | 4.86 | 5.07 | 6.18 | 2.50 | 2.47 | 3.68 | 5.22 | 5.31 | 2.46 |
| (Rn₃O + RO) | | | | | | | | | |

TABLE 2

| PHYSICAL | EXAMPLES | | | | | | | | |
|---|---|---|---|---|---|---|---|---|---|
| PROPERTIES | 1 | 2 | 3 | 4 | 5 | 6 | 7 | 8 | 9 |
| Refractive | 1.52136 | 1.51866 | 1.48300 | 1.62676 | 1.63054 | 1.59410 | 1.51568 | 1.51595 | 1.60502 |
| index (n_{d}) | | | | | | | | | |
| Abbe | 64.00 | 64.00 | 70.60 | 56.60 | 55.20 | 35.46 | 64.00 | 64.06 | 43.70 |
| number (v _{d}) | | | | | | | | | |
| α (−30 to | 78 | 78 | 103 | 66 | 67 | 98 | 79 | 78 | 88 |
| 70° C.) | | | | | | | | | |
| α (100 to | 91 | 90 | 108 | 77 | 78 | 107 | 92 | 89 | 103 |
| 300° C.) | | | | | | | | | |
| [×10⁻²×⁻¹] | | | | | | | | | |
| Tg | 564 | 564 | 488 | 663 | 659 | 487 | 555 | 560 | 592 |
| At | 633 | 636 | 580 | 724 | 705 | 556 | 626 | 635 | 656 |
| Specific | 2.55 | 2.53 | 2.45 | 3.58 | 3.58 | 2.64 | 2.51 | 2.51 | 2.91 |
| gravity | | | | | | | | | |
| Young's | 80.6 | 79.8 | 62.9 | 84.2 | 85.3 | 64.6 | 79.2 | 79.3 | 75.3 |
| modulus E | | | | | | | | | |
| [Gpa = | | | | | | | | | |
| ×10⁹Pa] | | | | | | | | | |
| Poisson's | 0.216 | 0.212 | 0.231 | 0.268 | 0.269 | 0.246 | 0.208 | 0.213 | 0.247 |
| ratio v | | | | | | | | | |
| CCI (B) | 0.00 | 0.00 | 0.00 | 0.00 | 0.00 | 0.00 | 0.00 | 0.00 | 0.00 |
| CCI (G) | 0.03 | 0.03 | 0.01 | 0.27 | 0.51 | 0.63 | 0.03 | 0.03 | 0.54 |
| CCI (R) | 0.00 | 0.00 | 0.00 | 0.26 | 0.46 | 0.63 | 0.00 | 0.00 | 0.52 |
| S(E · α/(1-v)) | 0.94 | 0.91 | 0.88 | 0.89 | 0.91 | 0.92 | 0.92 | 0.90 | 1.03 |
| [×10⁶Pa/° C.] | | | | | | | | | |

As described above, in the case of an optical glass used in the manufacture of a wearable or mobile device that is not necessarily required to have a high refractive index, not only the B value but also the G and R values of the ISO/CCI of a glass bulk material may be small since a high refractive index is not required. In the optical glass according to the present disclosure, good color balance can be ensured, and an optical glass having a color contribution index with a low degree of color change can be obtained. Furthermore, an optical element made using the optical glass having a color contribution index with a low degree of color change can provide a user with an image or video that is closer to actual colors, and is therefore suitable for wearable applications such as AR, VR, and MR, as well as for mobile device applications.

The present disclosure provides an optical glass having: a refractive index (n_{d}) that is in a range relatively lower than conventional ones; and a color contribution index with a low degree of color change, the optical glass having excellent formability, high stability in a manufacturing process, and excellent color correction ability in a wide region. The optical glass is suitable for wearable applications such as AR (augmented reality), VR (virtual reality), and MR (mixed reality) and for mobile device applications.

1. An optical glass,
wherein a refractive index (n_{d}) at a wavelength of the d line of helium (587.6 nm) is in a range of 1.45000 to 1.65000,
an ISO color contribution index ISO/CCI is 0.00 for blue (B), 0.80 or less for green (G), and 0.80 or less for red (R), and
an S value obtained by the following equation (1) is 0.70×10⁶ or more and less than 1.03×10⁶ (Pa/° C.),
S=E·α/(1−ν) Equation (1), in which
E is Young's modulus (unit: GPa),
α is an average coefficient of linear expansion in a temperature range of 100° C. to 300° C. (unit: 10⁻⁷° C.⁻¹), and
ν is Poisson's ratio.

2. The optical glass according to claim 1, wherein an upper limit value of the refractive index (n_{d}) is 1.64000.

3. The optical glass according to claim 1, wherein the ISO color contribution index ISO/CCI is 0.00 for blue (B), 0.70 or less for green (G), and 0.70 or less for red (R).

4. The optical glass according to claim 1, wherein the S value is 0.73×10⁶ or more and less than 1.00×10⁶ (Pa/° C.).

5. The optical glass according to claim 1, wherein a total content of a TiO₂ component, a Nb₂O₅ component, a Bi₂O₃ component, and a WO₃ component is 10.0% or less by mol % in terms of oxide.

6. The optical glass according to claim 1, comprising, by mol % in terms of oxide:
30.0 to 80.0% of a SiO₂ component; and
0.00 to 30.0% of a B₂O₃ component,
in a sum that does not exceed 100.0%.

7. An optical element, comprising: the optical glass according to claim 1.

8. The optical element according to claim 7, wherein the optical element is used with a transparent resin plate or a curable resin material.

9. The optical element according to claim 7, wherein the optical element is used in a wearable device or a mobile device.
